(19) United States
(12) Patent Application Publication
(10) Pub. No.: US 2025/0290557 A1
(43) Pub. Date: Sep. 18, 2025

(54) SYSTEM FOR CONTROLLING VIBRATION DAMPING OF TRACTOR REAR HITCH, AND TRACTOR

(71) Applicants: JiangSu XCMG Construction Machinery Research Institute LTD., Jiangsu (CN); Xuzhou XCMG Agricultural Equipment Technology Co., Ltd, Jiangsu (CN)

(72) Inventors: Xiao ZHANG, Jiangsu (CN); Haoliang QIN, Jiangsu (CN); Sichen LI, Jiangsu (CN); Hongbo ZHANG, Jiangsu (CN)

(73) Assignees: JiangSu XCMG Construction Machinery Research Institute LTD., Jiangsu (CN); Xuzhou XCMG Agricultural Equipment Technology Co., Ltd, Jiangsu (CN)

(21) Appl. No.: 18/861,216

(22) PCT Filed: Dec. 7, 2022
(86) PCT No.: PCT/CN2022/137208

§ 371 Date: Oct. 29, 2024

(30) Foreign Application Priority Data
May 13, 2022 (CN) 202210519050.5

(51) Int. Cl. F16F 15/023; A01B 63/10

(52) U.S. Cl. CPC F16F 15/023; A01B 63/10; F16F 2230/08; F16F 2230/18

(57) ABSTRACT

The present invention discloses a system for controlling vibration damping of a tractor rear hitch, and a tractor, in the technical field of vibration control for tractor rear hitches. The system includes: a tractor operation parameter acquisition device for acquiring operation parameters of a tractor; a controller for sending a control signal to an actuator based on the acquired operation parameters of the tractor according to a set vibration damping control strategy; and the actuator for controlling, based on the control signal sent by the controller, a quantity of hydraulic oil flowing into and out of a rodless cavity of a hitch oil cylinder of a rear hitch mechanism of the tractor, to allow for vibration damping of the rear hitch mechanism of the tractor and maintain the rear hitch mechanism within a set damping section, during transport.

### TECHNICAL FIELD

The present invention belongs to the technical field of vibration control for tractor rear hitches, and in particular, relates to a system for controlling vibration damping of a tractor rear hitch, and a tractor.

### TECHNICAL BACKGROUND

A tractor carries out various field operations by virtue of different implements, which are generally connected to a tractor body by virtue of a three-point hitch mechanism. In general, an implement is directly suspended and connected to the tractor, which then travels to and operates in a field. After completing field operations in some farmland, the tractor generally needs to carry the implement for transport, so as to carry out operations on other farmland. During the transport, in case of a higher driving speed, the tractor may vibrate on a whole when traveling on a road full of hollows or bumps; and in particular when carrying a heavy-duty implement, the tractor may be caused to shake, the implement and the tractor body interact with each other, and an operator feels obvious vibrations in a cab, leading to poor comfort. In some cases of large vibrations, the front wheels of the tractor get off the ground, which is likely to bring about safety problems.

In the prior art, a mechanical hitch system is used, basically without a damping device, which is achieved only by elastic tires that however show a limited damping effect. A tractor equipped with an electrical-hydraulic hitch system has disadvantages as follows:
(1) A solenoid valve is in a direct drive control mode; after a controller specifies the current. the solenoid valve takes a certain time to rise from the minimum current to the maximum current, and then, a valve spool conducts an actual action, followed by the establishment of a load pressure by the system, allowing hydraulic oil to enter an oil cylinder to promote the actual action of a hitch mechanism; the whole process from turn-on control to actual action has a long response time and thus fails to achieve accurate turn-on, such that quick trigger for vibration damping and pressure relief is not allowed under vibrations and high pressure; furthermore, during closing, there is also a delay occurring to the current of the solenoid valve and the closing of the valve spool, such that stable and accurate closing is not allowed, resulting in a weak vibration damping effect, or even aggravating vibrations;
(2) A fixed current is specified during vibration damping: the load from the heavy-duty implement needs to be overcome during lifting, and the heavy-duty implement tends to decline in gravity during lowering; with the same current adjustment specified, the pressure change caused by vibrations under different working conditions varies; and thus, the fixed current affects the time of the adjustment process and the damping effect;
(3) It hasn't disclosed how to further perform lifting or lowering when reaching the upper and lower boundary limits of a damping region; and in a case where the lifting and lowering processes are different in operation cycle, oscillations will be aggravated, or even safety problems will be caused;
(4) A throttle valve or a relief valve is disposed in the large or small cavity of the oil cylinder; in case of large flow, the smaller throttle valve does not allow for unloading, with high pressure maintained; the use of the relief valve allows for pressure relief under an overflow value, which, however, is set as a fixed value; if the overflow value is set smaller, other functions of electrical-hydraulic lifting will be affected on the one hand, and on the other hand, when the vibration damping function is not enabled, smaller impacts cause unloading to thus lead to automatic lowering of the implement, bringing about safety problems easily; and if the overflow value is set larger, the vibration damping effect cannot be achieved for the high pressure caused by some vibrations;
(5) The vibration damping process involves fine adjustment under high pressure; for the load-sensitive system of a fixed-displacement pump, the hydraulic pump outputs all the oil; during vibration damping with adjustment, part of the oil acts under high pressure, and the rest of the oil undergoes unloading under high pressure; and during vibration damping without adjustment, all the oil undergoes unloading from a fixed-difference relief valve, leading to a large temperature rise to affect the heat balance performance of the system.

### SUMMARY OF THE INVENTION

In order to overcome the defects of the prior art, the present invention provides a system for controlling vibration damping of a tractor rear hitch, and a tractor, which can effectively control vibrations of the tractor rear hitch, improve the driving comfort of an operator, and avoid safety problems caused by excessive vibrations.

To achieve the object above, the present invention employs the following technical solutions:

In a first aspect, a system for controlling vibration damping of a tractor rear hitch is provided. The system includes: a tractor operation parameter acquisition device for acquiring operation parameters of a tractor; a controller for sending a control signal to an actuator based on the acquired operation parameters of the tractor according to a set vibration damping control strategy; the actuator for controlling, based on the control signal sent by the controller, a quantity of hydraulic oil flowing into and out of a rodless cavity of a hitch hydraulic cylinder of a rear hitch mechanism of the tractor, to allow for vibration damping of the rear hitch mechanism of the tractor and maintain the rear hitch mechanism within a set damping section, during transport.

Further, the tractor operation parameter acquisition device includes: a force sensor installed between a lower pull rod of the rear hitch mechanism of the tractor and a hinge point of the tractor; and a position sensor installed on an elevating arm of the rear hitch mechanism of the tractor, wherein the force sensor and the position sensor are electrically connected to the controller, respectively.

Further, the actuator includes: a lifting valve, wherein an inlet of the lifting valve is connected to an outlet of a hydraulic pump, an outlet of the lifting valve is connected to the rodless cavity of the hitch hydraulic cylinder of the rear hitch mechanism of the tractor by means of a switch valve and a check valve, and the lifting valve receives the control signal from the controller to control the quantity of hydraulic oil flowing into the rodless cavity of the hitch hydraulic cylinder of the rear hitch mechanism of the tractor; a lowering valve, wherein an inlet of the lowering valve is connected to the rodless cavity of the hitch hydraulic cylinder of the rear hitch mechanism of the tractor, an outlet of the lowering valve is connected to a hydraulic oil tank, and the lowering valve receives the control signal from the controller to control the quantity of hydraulic oil flowing out of the rodless cavity of the hitch hydraulic cylinder of the rear hitch mechanism of the tractor; an unloading valve, by means of which the outlet of the hydraulic pump is connected to the hydraulic oil tank; and a fixed-difference compensator, by means of which the outlet of the hydraulic pump is connected to the hydraulic oil tank.

Further, when a transport position knob is turned on, the controller controls the lifting valve to be turned on and the unloading valve to be turned off, to lift an implement to a height set by a hitch height setting knob, and when a vibration damping trigger button is triggered, an implement transport vibration damping function is enabled, and the implement moves downwards on the basis of the height set by the hitch height setting knob and then stays at a middle position or a position in the damping section; and then, the unloading valve is sequentially turned on, and hydraulic oil output by the hydraulic pump directly flows into the hydraulic oil tank from the unloading valve.

Further, the controller monitors the vehicle speed of the tractor by means of a wheel speed sensor, and if the vehicle speed exceeds a first vehicle speed value, the controller controls the unloading valve to be turned off and hydraulic oil output by the hydraulic pump directly flows into the hydraulic oil tank from the fixed-difference compensator; the controller monitors a real-time force value of the force sensor, and if the force value is determined to increase continuously, the controller controls the lowering valve to perform oil unloading on the rodless cavity of the hitch hydraulic cylinder after the force value exceeds a first set value; if the force value is determined to decrease continuously, the controller controls the lifting valve to perform oil filling on the rodless cavity of the hitch hydraulic cylinder after the force value is smaller than a second set value; a force value increase process monitored by the force sensor is defined as a rising edge, the lowering valve acts at the rising edge of the force value, a force value decrease process monitored by the force sensor is defined as a falling edge, and the lifting valve acts at the falling edge of the force value; if a lower limit position of the damping section is approached or exceeded, the lifting valve is controlled to act when the force value decreases, to lift the rear hitch mechanism of the tractor and maintain the rear hitch mechanism within the damping section; and if an upper limit position of the damping section is approached, the lowering valve is controlled to act when the force value increases, to lower the rear hitch mechanism of the tractor and maintain the rear hitch mechanism within the damping section.

Damping process compensation control is performed for different positions in the damping section.

Further, at the rising edge of the force value, the lowering valve acts, and the vibration damping control strategy specifically includes:
when a force value a1 is monitored at a time t1, a time interval is set to T1, in a case where a force value b1 is monitored at any time within the time interval T1, for example, at a time t2, with t2−t1≤T1, the controller outputs a current m1 to the lowering valve, and if the force value b1 is not monitored within the time interval T1, the controller does not output a current to the lowering valve; with the force values a1 and b1 monitored, a time interval T2 is further set, if a force value c1 is monitored within the time interval T2, for example, at a time t3, the current output to the lowering valve by the controller increases to m2, and if the force value c1 is not monitored within the time interval T2, the current output to the lowering valve by the controller directly returns to zero from m1 after the time interval T2; with the force values a1, b1 and c1 monitored, a time interval T3 is further set, if a force value d1 is monitored within the time interval T3, for example, at a time t4, the current output to the lowering valve by the controller increases to m3, and if the force value d1 is not monitored within the time interval T3, the current output to the lowering valve by the controller directly returns to zero from m2 after the time interval T3; and with the force values a1, b1, c1 and d1 monitored, a time interval T4 is further set, if the force value decreases to d2 within the time interval T4, the current output to the lowering valve by the controller directly returns to zero, or else, the controller outputs a current m3 to the lowering valve and holds the current for the time interval T4, and the force value is greater than d2 at a time t5, for example, e1.

Further, if the force value continues to increase from e1 to f1 and then decreases to d2, or directly decreases from e1 to d2, the current output to the lowering valve by the controller is set using an interpolation method in said process; if the force value is preset within a range [d2, g] and g is preset as a maximum value in a range of the force sensor, a current corresponding to the force value in the range is within [m1, mg], with mg<m3; when the force value is within the range after the time interval T4, the controller sets the current within [m1, mg] using the interpolation method according to a correspondence between the force value and the current, and outputs a corresponding current; and when the force value is smaller than d2, the controller controls the current of the lowering valve to return to zero.

Further, at the falling edge of the force value, the lifting valve acts, and the vibration damping control strategy specifically includes: when the controller monitors a force value d2, which is monitored at a time t7, a time interval T5 is set, in a case where a force value c2 is monitored at any time within the time interval T5, for example, at a time t8, the controller outputs a current m4 to the lifting valve, and if the force value c2 is not monitored within the time interval T5, the controller does not output a current to the lifting valve; with the force values d2 and c2 monitored, a time interval T6 is further set, if a force value b2 is monitored within the time interval T6, for example, at a time t9, the current output to the lifting valve by the controller increases to m5, and if the force value b2 is not monitored within the time interval T6, the current output to the lifting valve by the controller directly returns to zero from m4 after the time interval T6; with the force values d2, c2 and b2 monitored, a time interval T7 is further set, if a force value a2 is monitored within the time interval T7, for example, at a time t10, the current output to the lifting valve by the controller increases to m6, and if the force value a2 is not monitored within the time interval T7, the current output to the lifting valve by the controller directly returns to zero from m5 after the time interval T7; and with the force values d2, c2, b2 and a2 monitored, a time interval T8 associated with engine speed information is further set decreasingly from an idle speed to a maximum speed, if the force value increases to a3 within the time interval T8, the current output to the lifting valve by the controller directly returns to zero, or else, the controller outputs a current m6 and holds the current for the time interval T8, and the force value is smaller than a3 at a time t11, for example, e2.

Further, if the force value continues to decrease from e2 to f2, which is a minimum value at a current working condition, and then increases from f2 to a3, or directly increases from e2 to a3, the current output by the controller is set using an interpolation method in said process; if the force value is preset within a range [a3, 0], a current corresponding to the force value in the range is within [m4, mh], with mh<m6; if the force value is within the range after the time interval T8, the controller sets the current within [m4, mh] using the interpolation method according to a correspondence between the force value and the current, and outputs a corresponding current; and when the force value is greater than a3, the controller controls the current of the lifting valve to return to zero.

Further, at the rising edge of the force value, when the implement is lowered to a position at a distance S2 from a lower limit position L of the damping section, the controller monitors a current actual execution state, if a pressure-relief damping process has not been completed, that is, the force value has not decreased below d2, the controller continues to output a current to the lowering valve, and after the force value decreases to below d2, the current output to the lowering valve by the controller returns to zero to ensure that the high-pressure damping process is completely implemented instead of being stopped immediately at the lower limit position, and a position of the implement is below or close to the lower limit position L; the controller monitors a change in force value of the force sensor, when the controller successively monitors force values a1, b1 and c1 within a time interval, the rising edge is determined and the lifting valve does not act, and when the controller monitors a force value d2 and monitors c2 within a time interval T11, the controller outputs a current m11 to the lifting valve; with the force values d2 and c2 monitored, when a force value b2 is monitored within a time interval T12, the current output to the lifting valve by the controller directly increases to m12, or else, the controller controls the lifting valve to hold the current m11 for T12, and the output current then returns to zero; with the force values d2, c2 and b2 monitored, when a force value a2 is further monitored within a time interval T13, the controller controls the current of the lifting valve to increase to m13, a hold time T14 is set, within which when the implement reaches a middle position or a position in the damping section, the current output to the lifting valve by the controller returns to zero, or else, after the hold time T14, the controller controls the current of the lifting valve to decrease to m14, which is held till the implement is lifted to the middle position or the position in the damping section; and with d2, c2 and b2 monitored, when the force value a2 is not monitored within the time interval T13, the controller controls the current of the lifting valve to be m14, which returns to zero after the implement is lifted to the middle position or the position in the damping section.

Further, at the falling edge of the force value, when a distance between an actual position of the implement and an upper limit position U of the damping section is S1 in a process where the lifting valve controls the implement to be lifted, the controller controls the current of the lifting valve to return to zero, and a position of the implement is or is close to the upper limit position U; the controller monitors a change in force value of the force sensor, when force values d2, c2 and b2 are successively monitored within a time interval, the falling edge is determined and the lowering valve does not act, and when the controller monitors a force value a1 and monitors b1 within a time interval T15, the controller outputs a current m15 to the lowering valve; with the force values a1 and b1 monitored, when a force value c1 is monitored within a time interval T16, the current output to the lifting valve by the controller directly increases to m16, or else, the controller controls the current m15 of the lowering valve to be maintained for T16, and the output current then returns to zero; with the force values a1, b1 and c1 monitored, when a force value d1 is further monitored within a time interval T17, the controller controls the current of the lowering valve to increase to m17, a hold time is set to T17, within which when the implement is lowered to a middle position or a position in the damping section, the output current returns to zero, or else, after the hold time T17, the controller controls the current to decrease to m18, which is maintained till the implement is lowered to the middle position or the position in the damping section; and with the force values a1, b1 and c1 monitored, when the force value d1 is not monitored within the time T17, the controller controls the current of the lowering valve to be m18, which returns to zero after the implement is lowered to the middle position or the position in the damping section.

Further, in order to prevent the implement from touching a ground after being lowered below the lower limit position by a long distance during damping at the rising edge, when the implement is lowered to a position P below the lower limit position, the damping at the rising edge is forcibly stopped, and the controller controls the lifting valve to perform lifting at a current m14, which returns to zero after the implement is lifted to the middle position or the position in the damping section.

Further, different compensation coefficients are set depending on the position where the damping section is located; when a height limit is at the upper limit position U, force values a, b, c and d are set as trigger determination conditions, and a different compensation coefficient K in a range of [0.8. 1.2] is set for a further implement damping position; when the height limit is higher than the upper limit position U, a value in a range [0.8. 1] is selected as K, the higher the height limit than the upper limit position U, the closer the compensation coefficient K is to 0.8, and the lower the determination force value triggered; and when the height limit is lower than the upper limit position U, a value in a range (1, 1.2] is selected as the compensation coefficient K, the lower the height limit than the upper limit position U, the closer the compensation coefficient is to 1.2, and the higher the determination force value triggered.

In a second aspect, a tractor s provided. The tractor is configured with the system for controlling vibration damping of a tractor rear hitch described in the first aspect.

Compared with the prior art, the present invention achieves the beneficial effects as follows:
(1) According to the present invention, the tractor operation parameter acquisition device acquires the operation parameters of the tractor; the controller sends a control signal to the actuator based on the acquired operation parameters of the tractor according to the set vibration damping control strategy; the actuator controls, based on the control signal sent by the controller, the quantity of hydraulic oil flowing into and out of the rodless cavity of the hitch hydraulic cylinder of the rear hitch mechanism of the tractor, to maintain the rear hitch mechanism of the tractor within the set damping section, which can effectively control vibrations of the tractor rear hitch, improve the driving comfort of the operator, and avoid the safety problems caused by excessive vibrations;
(2) The present invention allows for timely hitch cylinder oil unloading of the tractor with the heavy-duty implement under high pressure at the rising edge of the damping range during transport, thereby achieving vibration damping;
(3) The present invention allows for timely hitch cylinder oil filling of the tractor with the heavy-duty implement on the falling edge of the damping range during transport, thereby achieving stable implement lifting without aggregating vibrations;
(4) The present invention allows for stable transition of the tractor on the boundary of the damping range, thereby achieving a consistent damping effect and ensuring the safety control for the transferred implement;
(5) The present invention achieves the damping effect for the implement at different set positions;
(6) The present invention achieves energy-saving control for the tractor during transport.

### DESCRIPTION OF THE DRAWINGS

FIG. 1 is a diagram showing the principle of a system for controlling vibration damping of a tractor rear hitch according to an embodiment of the present invention (a schematic diagram of a double-acting oil cylinder);

FIG. 2 is a schematic diagram of a force value trigger process at rising and falling edges according to an embodiment of the present invention;

FIG. 3 is a schematic diagram of a current specifying process at rising and falling edges according to an embodiment of the present invention;

FIG. 4 is a schematic diagram of a current specifying process at upper and lower limit positions according to an embodiment of the present invention; and

FIG. 5 is a schematic diagram of a damping section according to an embodiment of the present invention.

In the figures: 1, hydraulic pump; 2, unloading valve; 3, fixed-difference compensator; 4, lifting valve; 5, lowering valve; 6, switch valve; 7, check valve; 8, hitch hydraulic cylinder; 9, force sensor; 10, position sensor; 11, controller; 12, engine speed information; 13, hitch height setting knob; 14, vibration damping trigger button; 15, transport position knob; 16, wheel speed sensor; 17, vibration damping state.

### DETAILED DESCRIPTION OF THE EMBODIMENTS

The present invention is further described below in conjunction with the accompanying drawings. The following embodiments are only used to more clearly illustrate the technical solutions of the present invention, and should not be construed as limiting the protection scope of the present invention.

### Embodiment 1

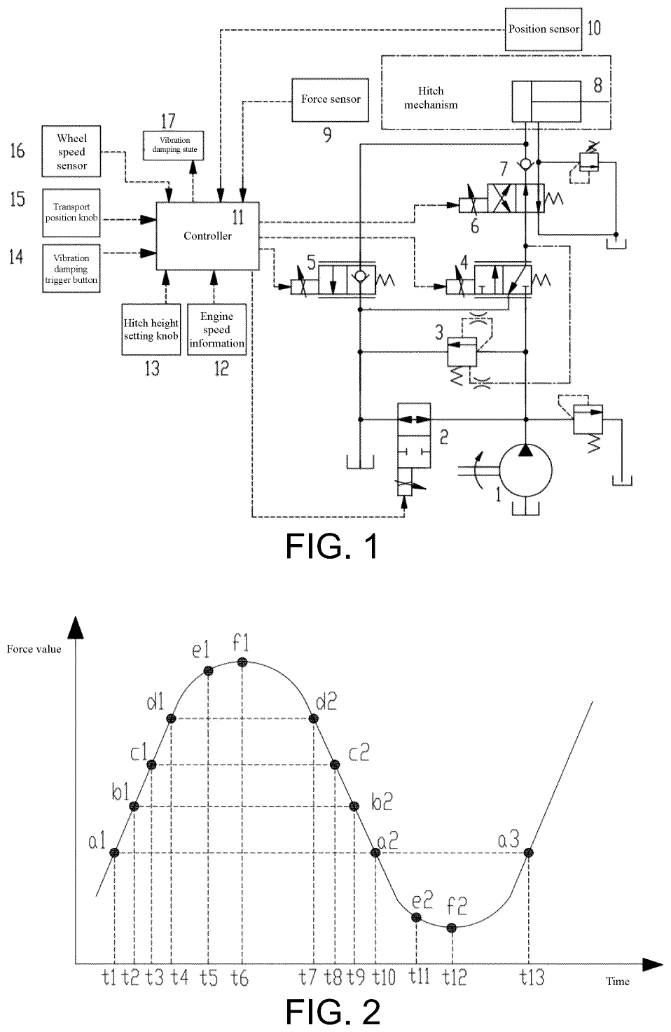

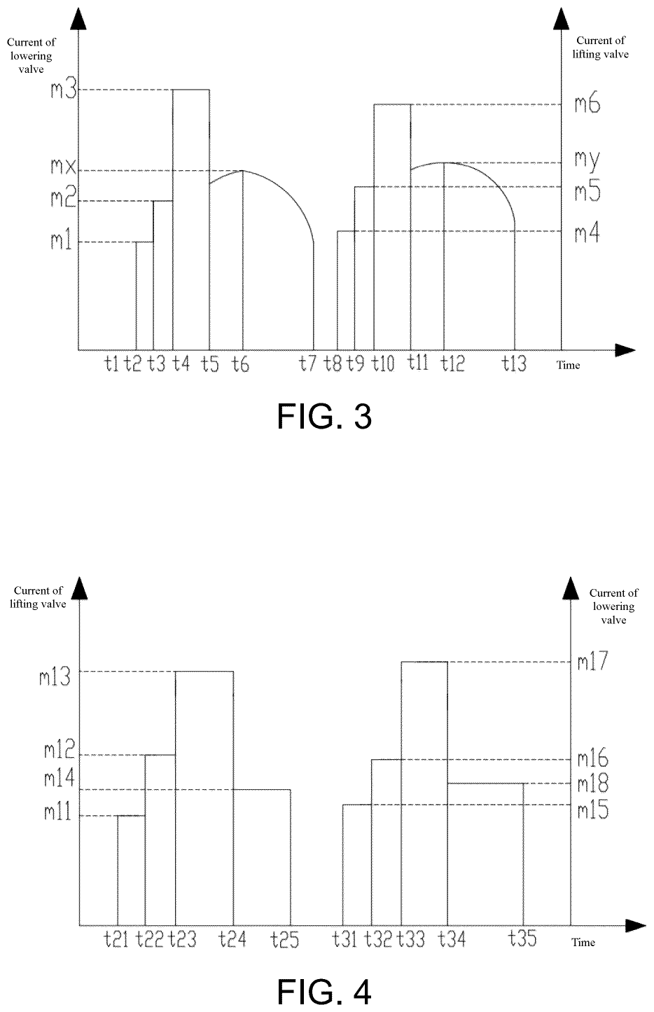

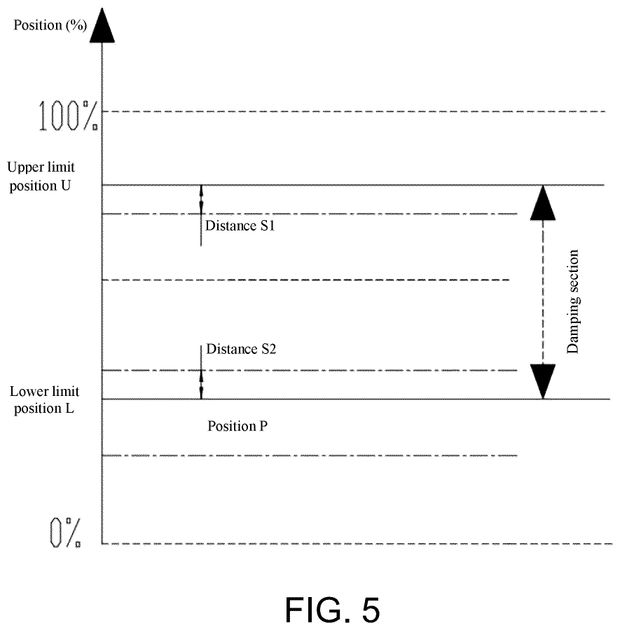

As shown in FIGS. 1 to 5, a system for controlling vibration damping of a tractor rear hitch includes: a tractor operation parameter acquisition device for acquiring operation parameters of a tractor; a controller 11 for sending a control signal to an actuator based on the acquired operation parameters of the tractor according to a defined vibration damping control strategy; the actuator for controlling, based on the control signal sent by the controller 11, a quantity of hydraulic oil flowing into and out of a rodless cavity of a hitch hydraulic cylinder 8 of a rear hitch mechanism of the tractor, to allow for vibration damping of the rear hitch mechanism of the tractor and maintain the rear hitch mechanism within a defined damping section, during transport.

The movement range of the implement carried by the rear hitch mechanism of the tractor is determined by the power stroke of the rear hitch hydraulic cylinder, of which the power stroke from full retraction to full extension corresponds to the lowest (0%) and highest (100%) positions of the implement, and an electrical-hydraulic elevation system may define the highest position of the implement according to the structural layout of the implement and tractor. During transport of the tractor, the implement is generally allowed to stay at a height limit position. Before vibration-damping control is enabled, a lifting/lowering section is required for the implement to allow for vibration-damping control. As shown in FIG. 5, an upper limit position is the height limit position of the implement, a lower limit position is a lower boundary for lowering the implement during vibration damping, and a section between the upper limit position and the lower limit position is a damping section.

The tractor operation parameter acquisition device includes: a force sensor 9 installed between a lower pull rod of the rear hitch mechanism of the tractor and a hinge point of the tractor; and a position sensor 10 installed on an elevating arm of the rear hitch mechanism of the tractor, wherein the force sensor 9 and the position sensor 10 are electrically connected to the controller 11, respectively.

The actuator includes a lifting valve 4 and a lowering valve 5. An inlet of the lifting valve 4 is connected to an outlet of a hydraulic pump 1, an outlet of the lifting valve 4 is connected to the rodless cavity of the hitch hydraulic cylinder 8 of the rear hitch mechanism of the tractor by means of a switch valve 6 and a check valve 7, and the lifting valve 4 receives the control signal from the controller 11 to control the quantity of hydraulic oil flowing into the rodless cavity of the hitch hydraulic cylinder 8 of the rear hitch mechanism of the tractor. An inlet of the lowering valve 5 is connected to the rodless cavity of the hitch hydraulic cylinder 8 of the rear hitch mechanism of the tractor, an outlet of the lowering valve 5 is connected to a hydraulic oil tank, and the lowering valve 5 receives the control signal from the controller 11 to control the quantity of hydraulic oil flowing out of the rodless cavity of the hitch hydraulic cylinder 8 of the rear hitch mechanism of the tractor. The outlet of the hydraulic pump 1 is connected to the hydraulic oil tank by means of an unloading valve 2; and, the outlet of the hydraulic pump 1 is connected to the hydraulic oil tank by means of a fixed-difference compensator 3.

The hydraulic pump 1 outputs the hydraulic oil and is connected to the unloading valve 2, the fixed-difference compensator 3 and the electric proportional lifting valve 4, and then connected to the rodless cavity of the hitch hydraulic cylinder 8 through the switch valve 6 and the check valve 7, and, the oil in the rodless cavity of the hitch hydraulic cylinder 8 is connected to the lowering valve 5. The controller 11 acquires real-time force value information by means of the force sensor 9 (arranged between the lower pull rod of the hitch mechanism and the hinge point of the tractor), determines the real-time position information of the implement by means of the position sensor 10 (arranged on the elevation arm), acquires tractor speed information by means of a wheel speed sensor 16, and acquires engine speed information by means of a CAN bus. A hitch height setting knob 13 is used for setting different highest position limits of the implement; a transport position knob 15 controls the implement of the tractor to enter a transport mode; a vibration damping trigger button 14 is used for activating a vibration damping function; and the controller 11 outputs a current to control the lifting valve 4 and the lowering valve 5 according to a vibration damping control strategy, and controls the unloading valve 2 according to a control logic.

When a transport position knob 15 is turned on, the controller 11 outputs a current to control the lifting valve 4 to be turned on and the unloading valve 2 to be turned off, to lift an implement to a height (determined by a position sensor 10) set by the hitch height setting knob 13, and when the vibration damping trigger button 14 is triggered, an implement transport vibration damping function is enabled; and the implement moves downwards on the basis of a height limit position in the preset damping section, and then stays at a middle position or a position in the damping section. Then, the unloading valve 2 is sequentially turned on, and hydraulic oil output by the hydraulic pump 1 is directly unloaded from the unloading valve 2, thereby saving energy and reducing heat production of the system. Further, the controller 11 monitors the speed information of the tractor; if the speed exceeds a speed value (a first speed value, N km/h) at this moment, the controller controls the unloading valve 2 to be turned off, and the hydraulic oil output by the hydraulic pump 1 is directly unloaded from the fixed-difference compensator 3; at this moment, the controller 11 monitors a real-time force value (a pull force) of a pull force sensor 9, and if the force value is determined to increase continuously, the controller 11 controls the lowering valve 5 to perform oil unloading on the rodless cavity of the hitch hydraulic cylinder 8 after the force value exceeds a value (a first set value); if the force value monitored decreases continuously, the controller 11 controls the lifting valve 4 to perform oil filling on the rodless cavity of the hitch hydraulic cylinder 8 after the force value is smaller than a value (a second set value); if a lower limit position of the damping section is approached or exceeded, lifting is carried out when the force value decreases; and if an upper limit position is approached, lowering is carried out when the force value increases, to maintain the implement within the damping section. In the actual acting process, considering the rapidity of the sudden change in pressure impact caused by a bumpy road, the frequency response of the proportional valve, the influence of valve spool friction and other problems on the timeliness of the control process, the following detailed control strategy integration is made to solve the problem of rapid response in the vibration damping control process.

A force value increase process monitored by the force sensor 9 is defined as a rising edge, the lowering valve 5 acts at the rising edge of the force value, a force value decrease process monitored by the force sensor 9 is defined as a falling edge, and the lifting valve 4 acts at the falling edge of the force value.

The vibration damping control strategy at the rising edge is shown in FIGS. 2 to 4:
When an active damping function is enabled for the tractor, an indicator light of a vibration damping state 17 lights up, and the active damping function is activated. In case of a bumpy road, with the increase of the force value, a force value a1 is monitored at a time t1, a time interval is set to T1 ms, and a force value b1 is monitored at any time within this time interval (for example, at a time t2, with t2−t1≤T1). Then, the controller 11 outputs a current m1 to the lowering valve 5 to allow the solenoid valve to act. If the force value b1 is not monitored within the time interval T1 ms, the controller 11 does not output a current to the lowering valve 5;
With the force values a1 and b1 monitored, a time interval T2 ms is further set; if a force value c1 is monitored within this time interval (for example, at a time t3), the current output to the lowering valve 5 by the controller 11 increases to m2; and if the force value c1 is not monitored within this time interval, the current output to the lowering valve 5 by the controller 11 directly returns to zero from m1 after the time interval T2 ms;
With the force values a1, b1 and c1 monitored, a time interval T3 ms is further set; if a force value d1 is monitored within this time interval T3 (for example, at a time t4), the current output to the lowering valve 5 by the controller 11 increases to m3; and if the force value d1 is not monitored within this time interval, the current output to the lowering valve 5 by the controller 11 directly returns to zero from m2 after the time interval T3 ms;
With the force values a1, b1, c1 and d1 monitored, a time interval T4 ms is further set; if the force value decreases to d2 again within T4 ms, the current output to the lowering valve 5 by the controller 11 directly returns to zero, or else, the controller 11 outputs a current m3 to the lowering valve 5 and holds the current for the time interval T4 ms (the force value is greater than d2 at a time t5, for example, e1). At this moment, if the force value continues to increase from e1 to f1 (the maximum value at the current working condition) and then decreases to the force value d2 (d1=d2 in FIG. 2), or directly decreases to the force value d1 from e1, the current output to the lowering valve 5 by the controller 11 is set using an interpolation method in this process; if the force value is preset within a range [d2, g] with g being the maximum value in the range of the force sensor, a current corresponding to the force value in this interval is within [m1, mg], with mg<m3; when the force value is within this interval after the time interval T4, the controller 11 sets the current within [m1, mg] using the interpolation method according to a correspondence between the force value and the current, and outputs a corresponding current; and if f1 at a peak point corresponds to a current value mx, when the force value is smaller than d2, the controller controls the current of the lowering valve 5 to return to zero.

The vibration damping control strategy at the falling edge is shown in FIGS. 2 to 4:
When the controller 11 monitors a force value d2 (at a time t7), a time interval T5 ms is set, a force value c2 is monitored at any time within this time interval (for example, at a time t8), the controller 11 outputs a current m4 to the lifting valve 4, and if the force value c2 is not monitored within this time interval, the controller 11 does not output a current to the lifting valve 4;
With the force values d2 and c2 monitored, a time interval T6 ms is further set; if a force value b2 is monitored within this time interval (for example, at a time t9), the current output to the lifting valve 4 by the controller 11 increases to m5; and if the force value b2 is not monitored within the time interval T6 ms, the current output to the lifting valve 4 by the controller 11 directly returns to zero from m4 after the time interval T6 ms;
With the force values d2, c2 and b2 monitored, a time interval T7 ms is further set; if a force value a2 is monitored within the time interval T7 (for example, at a time t10), the current output to the lifting valve 4 by the controller 11 increases to m6; and if the force value a2 is not monitored within this time interval, the current output to the lifting valve 4 by the controller 11 directly returns to zero from m5 after the time interval T7 ms;
With the force values d2, c2, b2 and a2 monitored, a time interval T8 ms associated with engine speed information 12 is further set decreasingly from an idle speed to a maximum speed. If the force value reaches the force value a3 (a1=a2=a3 in FIG. 2) again within T8 ms, the current output to the lifting valve 4 by the controller 11 directly returns to zero, or else, the controller 11 outputs the current m6 and holds the current for T8 (the force value is smaller than a3 at a time t11, for example, e2). At this moment, if the force value continues to decrease from e2 to f2 (which is the minimum value at the current working condition) and then increases from f2 to a3 (at the time t13), or directly increases from e2 to a3, the current output by the controller 11 is set using an interpolation method in this process; if the force value is preset within a range [a3, 0], a corresponding current is within [m4, mh], with mh<m6; after the force value is within this interval, the controller 11 sets the current within [m4, mh] using the interpolation method according to a correspondence between the force value and the current, and outputs a corresponding current; and if f2 at a valley point corresponds to a current value my, when the force value is greater than a3, the controller 11 controls the current of the lifting valve 4 to return to zero.

For the upper and lower boundaries of the damping section, when the position of the implement approaches the upper or lower boundary, further control is needed to ensure further damping and safe control.

At a lower boundary, the lifting valve 4 acts, and the vibration damping control strategy is specifically as follows:
At the rising edge of the force value, in the process where the controller 11 controls the lowering valve 5 to act, when the implement is lowered to a position at a distance (for example, a distance S2) from the lower limit position L of the damping section, the controller 11 at this moment monitors a current actual execution state; if a pressure-relief damping process has not been completed (the force value has not decreased below a value d2), the controller 11 continues to output a current to the lowering valve 5, and the current output to the lowering valve 5 by the controller 11 returns to zero after the force value decreases below d2. This ensures that the high-pressure damping process is completely implemented instead of being stopped immediately at the lower limit position, the position of the implement at this moment is below or close to the lower limit position L, and the controller 11 monitors the change in force value of the force sensor:
When the controller monitors force value data and successively monitors, for example, force values a1, b1 and c1 within a time interval, the rising edge is determined and the lifting valve 4 does not act, and when the controller 11 monitors a force value d2 and monitors c2 within a time interval T11 ms, the controller 11 outputs a current m11 to the lifting valve 4. With the force values d2 and c2 monitored, when a force value b2 is monitored within a time interval T12 ms, the current output to the lifting valve 4 by the controller 11 directly increases to m12, or else, the controller 11 controls the current m11 of the lifting valve 4 to be maintained for T12 ms, and the output current then returns to zero. With the force values d2, c2 and b2 monitored, when a force value a2 is further monitored within a time interval T13 ms, the controller 11 controls the current of the lifting valve 4 to increase to m13, a hold time T14 ms is set, within which when the implement reaches a middle position or a position in the damping section, the current output to the lifting valve 4 by the controller 11 returns to zero, or else, after the hold time T14 ms, the controller 11 controls the current of the lifting valve 4 to decrease to m14, which is held till the implement is lifted to the middle position or the position in the damping section. With the force values d2, c2 and b2 monitored, when the force value a2 is not monitored within the time interval T13, the controller 11 controls the current of the lifting valve 4 to be m14, which returns to zero after the implement is lifted to the middle position or the position in the damping section.

Further, in order to prevent the position from being lowered below the lower limit position by a long distance when a damping action is completely executed during damping at the rising edge, a safe position is further set; when the implement is lowered to a position P below the lower limit position during damping, the damping at the rising edge is forcibly stopped; and the controller 11 controls the lifting valve 4 to perform lifting at a current m14, which returns to zero after the implement is lifted to the middle position or the position in the damping section.

At an upper boundary, the lowering valve 5 acts, and the vibration damping control strategy is specifically as follows:
At the falling edge of the force value, in the process where the controller 11 controls the lifting valve 4 to act, the implement is lifted to approach a position at a distance (for example, a distance S1) from the upper limit position U of the damping section, and the current of the lifting valve 4 is then directly controlled to return to zero to ensure safe control since the upper limit position is the set value of the height limit knob; at this moment, the position of the implement is at or close to the upper limit position, and the controller 11 monitors the change in pull force value of the force sensor as follows:
When the controller 11 monitors the force value data and successively monitors, for example, force values force values d2, c2 and b2 within a time interval, the falling edge is determined and the lowering valve 5 does not act; when the controller 11 monitors a force value a1 and monitors a force value b1 within a time interval T15 ms, the controller 11 outputs a current m15 to the lowering valve 5; with the force values a1 and b1 monitored, when a force value c1 is monitored within a time interval T16 ms, the current output to the lifting valve 4 by the controller 11 directly increases to m16, or else, the controller 11 controls the current m15 of the lowering valve 5 to be maintained for T16 ms, and the output current then returns to zero; with the force values a1, b1 and c1 monitored, when a force value d1 is further monitored within a time interval T17 ms, the controller 11 controls the current of the lowering valve 5 to increase to m17, a hold time is set to T17 ms, within which when the implement is lowered to a middle position or a position in the damping section, the output current returns to zero, or else, after T17 ms is held, the controller 11 controls the current to decrease to m18, which is held till the implement is lowered to the middle position or the position in the damping section; and with the force values a1, b1 and c1 monitored, when the force value d1 is not monitored within T17 ms. the controller 11 controls the current of the lowering valve 5 to be m18, which returns to zero after the implement is lowered to the middle position or the position in the damping section.

In the vibration damping mode, the controller 11 carries out determination and make a response in real time based on the real-time force value acquired by the force sensor 9 and the real-time implement position acquired by the position sensor 10, and repeats this process constantly.

### Different Positions in the Damping Section

Different compensation coefficients are set depending on a position where the damping section is located. For example, when a height limit is at the upper limit position U, force values a, b, c, d or the like are set as trigger determination conditions, and a different compensation coefficient K in a range of [0.8, 1.2] is set for a further implement damping position; when the height limit is higher than the upper limit position U, a value in a range [0.8. 1] is selected as K, the higher the height limit than the upper limit position U, the closer the compensation coefficient K is to 0.8, and the lower the determination force value triggered; and when the height limit is lower than the upper limit position U, a value in a range (1, 1.2] is selected as the compensation coefficient K, the lower the height limit than the upper limit position U, the closer the compensation coefficient is to 1.2, and the higher the determination force value triggered.

According to the present invention, at the rising edge of the force value, different lowering currents, maximum hold times and trigger end processes are correspondingly set for different force values, allowing for timely damping and oil unloading for the high pressure in the vibration process; and at the falling edge of the force value, different lifting currents, maximum hold times and trigger end processes are set for different force values and different engine speed information, allowing for timely oil filling of the hitch hydraulic cylinder and stable lifting of the implement. When the actual position of the implement approaches the lower limit position, if vibration damping and oil unloading are being conducted at this moment, the conduction of oil unloading is ensured, the lifting at the falling edge is monitored, and different currents and hold times are specified for different force values and actual implement positions, allowing for stable lifting at the lower limit position; and meanwhile, in order to ensure the consistency and safety of the oil unloading execution process, stop control is further added such that the implement cannot be lowered too much, thereby ensuring the safe control for the transport process. When the actual implement position approaches the upper limit position, if the lifting action is being conducted at this moment, it is stopped in time to ensure safety, the lowering at the falling edge is monitored, and different currents and hold times are specified for different force values and actual implement positions, allowing for stable lowering at the upper limit position. Different determination force values are set for different positions in the damping section to achieve the damping effect at different positions. The wheel speed information is monitored in real time; the vibration damping function is further determined based on the wheel speed information; at low speed, the hydraulic oil output by the pump is directly unloaded to save energy; and when the transport is conducted without enabling the vibration damping function, the hydraulic oil output by the pump is directly unloaded in a similar way, without the fixed-difference compensator for unloading, thereby saving energy and reducing heat production. According to the present invention, the problem of poor experience of an operator caused by obvious vibrations of the tractor due to vibrations of the heavier implement when the tractor is transported on a bumpy road is solved on a whole; the problem of aggravated vibrations caused by response delay in the vibration damping control process is solved, allowing for accurate pressure relief in case of high pressure, accurate oil filling in case of low pressure, and accurate vibration damping on the bumpy road; the problem of oscillations caused by the lifting/lowering control conducted after the upper and lower boundary limit positions are reached in the set damping section during the vibration damping control is solved, allowing for consistent and smooth lifting and lowering without aggravating the oscillations; and the heat production of the load-sensitive system of the fixed-displacement pump during transportation is reduced, achieving better system heat balance.

In this embodiment, different currents and different time intervals are used and can be finely adjusted based on the performance of the solenoid valve and the controller, the size of the tractor implement, the position of the vibration-attenuation damping section, the size of the damping section or the like; meanwhile, in this embodiment, four force values are used for each of the rising edge and the falling edge, and the number of force value points (for example, 3, 5 or more) can be determined and selected according to actual conditions; and, in this embodiment, the determination force values for the rising and falling edges can be the same, or different. depending on the conditions (for example, a1, a2 and a3 may be identical or different force values set depending on the conditions). In this embodiment, a double-acting oil cylinder is used, and it also applies to a single-acting oil cylinder.

### Embodiment 2

Based on the system for controlling vibration damping of a tractor rear hitch described in Embodiment 1, this embodiment provides a tractor configured with the system for controlling vibration damping of a tractor rear hitch described in Embodiment 1.

The description above only provides preferred embodiments of the present invention. For those of ordinary skills in the art, it should be noted that various improvements and variations can also be made without departing from the technical principle of the present invention, and these improvements and variations shall be construed as falling within the protection scope of the present invention.

1. A system for controlling vibration damping of a tractor rear hitch, comprising:
a tractor operation parameter acquisition device for acquiring operation parameters of a tractor;
a controller for sending a control signal to an actuator based on the acquired operation parameters of the tractor according to a defined vibration damping control strategy; and
the actuator for controlling, based on the control signal sent by the controller, a quantity of hydraulic oil flowing into and out of a rodless cavity of a hitch hydraulic cylinder of a rear hitch mechanism of the tractor, to allow for vibration damping of the rear hitch mechanism of the tractor and maintain the rear hitch mechanism within a defined damping section, during transport.

2. The system for controlling vibration damping of the tractor rear hitch according to claim 1, wherein the tractor operation parameter acquisition device comprises:
a force sensor installed between a lower pull rod of the rear hitch mechanism of the tractor and a hinge point of the tractor; and
a position sensor installed on an elevating arm of the rear hitch mechanism of the tractor,
wherein the force sensor and the position sensor are electrically connected to the controller, respectively.

3. The system for controlling vibration damping of the tractor rear hitch according to claim 2, wherein the actuator comprises:
a lifting valve, wherein an inlet of the lifting valve is connected to an outlet of a hydraulic pump, an outlet of the lifting valve is connected to the rodless cavity of the hitch hydraulic cylinder of the rear hitch mechanism of the tractor by means of a switch valve and a check valve, and the lifting valve receives the control signal from the controller to control the quantity of hydraulic oil flowing into the rodless cavity of the hitch hydraulic cylinder of the rear hitch mechanism of the tractor;
a lowering valve, wherein an inlet of the lowering valve is connected to the rodless cavity of the hitch hydraulic cylinder of the rear hitch mechanism of the tractor, an outlet of the lowering valve is connected to a hydraulic oil tank, and the lowering valve receives the control signal from the controller to control the quantity of hydraulic oil flowing out of the rodless cavity of the hitch hydraulic cylinder of the rear hitch mechanism of the tractor;
an unloading valve, by means of which the outlet of the hydraulic pump is connected to the hydraulic oil tank; and
a fixed-difference compensator, by means of which the outlet of the hydraulic pump is connected to the hydraulic oil tank.

4. The system for controlling vibration damping of the tractor rear hitch according to claim 3, wherein
when a transport position knob is turned on, the controller controls the lifting valve to be turned on and the unloading valve to be turned off, to lift an implement to a height set by a hitch height setting knob, and when a vibration damping trigger button is triggered, an implement transport vibration damping function is enabled, and the implement moves downwards on a basis of the height set by the hitch height setting knob and then stays at a middle position or a position in the damping section; and then, the unloading valve is sequentially turned on, and hydraulic oil output by the hydraulic pump directly flows into the hydraulic oil tank from the unloading valve.

5. The system for controlling vibration damping of the tractor rear hitch according to claim 3, wherein
the controller monitors a speed of the tractor by means of a wheel speed sensor, and if the speed exceeds a first speed value, the controller controls the unloading valve to be turned off and hydraulic oil output by the hydraulic pump directly flows into the hydraulic oil tank from the fixed-difference compensator;
the controller monitors a real-time force value of the force sensor, and if the force value is determined to increase continuously, the controller controls the lowering valve to perform oil unloading on the rodless cavity of the hitch hydraulic cylinder after the force value exceeds a first set value;
if the force value is determined to decrease continuously, the controller controls the lifting valve to perform oil filling on the rodless cavity of the hitch hydraulic cylinder after the force value is smaller than a second set value;
a force value increase process monitored by the force sensor is defined as a rising edge, the lowering valve acts at the rising edge of the force value, a force value decrease process monitored by the force sensor is defined as a falling edge, and the lifting valve acts at the falling edge of the force value;
if a lower limit position of the damping section is approached or exceeded, the lifting valve is controlled to act when the force value decreases, to lift the rear hitch mechanism of the tractor and maintain the rear hitch mechanism within the damping section; and
if an upper limit position of the damping section is approached, the lowering valve is controlled to act when the force value increases, to lower the rear hitch mechanism of the tractor and maintain the rear hitch mechanism within the damping section.

6. The system for controlling vibration damping of the tractor rear hitch according to claim 5, wherein at the rising edge of the force value, the lowering valve acts, and the vibration damping control strategy specifically comprises:
when a force value a1 is monitored at a time t1, a time interval is set to T1, in a case where a force value b1 is monitored at any time within the time interval T1, for example, at a time t2, with t2−t1≤T1, the controller outputs a current m1 to the lowering valve, and if the force value b1 is not monitored within the time interval T1, the controller does not output a current to the lowering valve;
with the force values a1 and b1 monitored, a time interval T2 is further set, if a force value c1 is monitored within the time interval T2, for example, at a time t3, the current output to the lowering valve by the controller increases to m2, and if the force value c1 is not monitored within the time interval T2, the current output to the lowering valve by the controller directly returns to zero from m1 after the time interval T2;
with the force values a1, b1 and c1 monitored, a time interval T3 is further set, if a force value d1 is monitored within the time interval T3, for example, at a time t4, the current output to the lowering valve by the controller increases to m3, and if the force value d1 is not monitored within the time interval T3, the current output to the lowering valve by the controller directly returns to zero from m2 after the time interval T3; and
with the force values a1, b1, c1 and d1 monitored, a time interval T4 is further set, if the force value decreases to d2 within the time interval T4, the current output to the lowering valve by the controller directly returns to zero, or else, the controller outputs a current m3 to the lowering valve and holds the current for the time interval T4, and the force value is greater than d2 at a time t5, for example, e1.

7. The system for controlling vibration damping of the tractor rear hitch according to claim 6, wherein if the force value continues to increase from e1 to f1 and then decreases to d2, or directly decreases from e1 to d2, the current output to the lowering valve by the controller is set using an interpolation method in said process; if the force value is preset within a range [d2, g] and g is preset as a maximum value in a range of the force sensor, a current corresponding to the force value in the range is within [m1, mg], with mg<m3; when the force value is within the range after the time interval T4, the controller sets the current within [m1, mg] using the interpolation method according to a correspondence between the force value and the current, and outputs a corresponding current; and when the force value is smaller than d2, the controller controls the current of the lowering valve to return to zero.

8. The system for controlling vibration damping of the tractor rear hitch according to claim 5, wherein at the falling edge of the force value, the lifting valve acts, and the vibration damping control strategy specifically comprises:
when the controller monitors a force value d2, which is monitored at a time t7, a time interval T5 is set, in a case where a force value c2 is monitored at any time within the time interval T5, for example, at a time t8, the controller outputs a current m4 to the lifting valve, and if the force value c2 is not monitored within the time interval T5, the controller does not output a current to the lifting valve;
with the force values d2 and c2 monitored, a time interval T6 is further set, if a force value b2 is monitored within the time interval T6, for example, at a time t9, the current output to the lifting valve by the controller increases to m5, and if the force value b2 is not monitored within the time interval T6, the current output to the lifting valve by the controller directly returns to zero from m4 after the time interval T6;
with the force values d2, c2 and b2 monitored, a time interval T7 is further set, if a force value a2 is monitored within the time interval T7, for example, at a time t10, the current output to the lifting valve by the controller increases to m6, and if the force value a2 is not monitored within the time interval T7, the current output to the lifting valve by the controller directly returns to zero from m5 after the time interval T7; and
with the force values d2, c2, b2 and a2 monitored, a time interval T8 associated with engine speed information is further set decreasingly from an idle speed to a maximum speed, if the force value increases to a3 within the time interval T8, the current output to the lifting valve by the controller directly returns to zero, or else, the controller outputs a current m6 and holds the current for the time interval T8, and the force value is smaller than a3 at a time t11, for example, e2.

9. The system for controlling vibration damping of the tractor rear hitch according to claim 8, wherein if the force value continues to decrease from e2 to f2, which is a minimum value at a current working condition, and then increases from f2 to a3, or directly increases from e2 to a3, the current output by the controller is set using an interpolation method in said process; if the force value is preset within a range [a3, 0], a current corresponding to the force value in the range is within [m4, mh], with mh<m6; if the force value is within the range after the time interval T8, the controller sets the current within [m4, mh] using the interpolation method according to a correspondence between the force value and the current, and outputs a corresponding current; and when the force value is greater than a3, the controller controls the current of the lifting valve to return to zero.

10. The system for controlling vibration damping of the tractor rear hitch according to claim 5, wherein at the rising edge of the force value, when an implement is lowered to a position at a distance S2 from a lower limit position L of the damping section, the controller monitors a current actual execution state, if a pressure-relief damping process has not been completed, that is, the force value has not decreased below d2, the controller continues to output a current to the lowering valve, and after the force value decreases to below d2, the current output to the lowering valve by the controller returns to zero and a position of the implement is below or close to the lower limit position L; the controller monitors a change in force value of the force sensor, when the controller successively monitors force values a1, b1 and c1 within a time interval, the rising edge is determined and the lifting valve does not act, and when the controller monitors a force value d2 and monitors c2 within a time interval T11, the controller outputs a current m11 to the lifting valve; with the force values d2 and c2 monitored, when a force value b2 is monitored within a time interval T12, the current output to the lifting valve by the controller directly increases to m12, or else, the controller controls the lifting valve to hold the current m11 for T12, and the output current then returns to zero; with the force values d2, c2 and b2 monitored, when a force value a2 is further monitored within a time interval T13, the controller controls the current of the lifting valve to increase to m13, a hold time T14 is set, within which when the implement reaches a middle position or a position in the damping section, the current output to the lifting valve by the controller returns to zero, or else, after the hold time T14, the controller controls the current of the lifting valve to decrease to m14, which is held till the implement is lifted to the middle position or the position in the damping section; and with d2, c2 and b2 monitored, when the force value a2 is not monitored within the time interval T13, the controller controls the current of the lifting valve to be m14, which returns to zero after the implement is lifted to the middle position or the position in the damping section.

11. The system for controlling vibration damping of the tractor rear hitch according to claim 5, wherein at the falling edge of the force value, when a distance between an actual position of an implement and an upper limit position U of the damping section is S1 in a process where the lifting valve controls the implement to be lifted, the controller controls the current of the lifting valve to return to zero, and a position of the implement is or is close to the upper limit position U; the controller monitors a change in force value of the force sensor, when force values d2, c2 and b2 are successively monitored within a time interval, the falling edge is determined and the lowering valve does not act, and when the controller monitors a force value a1 and monitors b1 within a time interval T15, the controller outputs a current m15 to the lowering valve; with the force values a1 and b1 monitored, when a force value c1 is monitored within a time interval T16, the current output to the lifting valve by the controller directly increases to m16, or else, the controller controls the current m15 of the lowering valve to be maintained for T16, and the output current then returns to zero; with the force values a1, b1 and c1 monitored, when a force value d1 is further monitored within a time interval T17, the controller controls the current of the lowering valve to increase to m17, a hold time is set to T17, within which when the implement is lowered to a middle position or a position in the damping section, the output current returns to zero, or else, after the hold time T17, the controller controls the current to decrease to m18, which is held till the implement is lowered to the middle position or the position in the damping section; and with the force values a1, b1 and c1 monitored, when the force value d1 is not monitored within the time T17, the controller controls the current of the lowering valve to be m18, which returns to zero after the implement is lowered to the middle position or the position in the damping section.

12. The system for controlling vibration damping of the tractor rear hitch according to claim 11, wherein in order to prevent the implement from touching a ground after being lowered below the lower limit position by a long distance during damping at the rising edge, when the implement is lowered to a position P below the lower limit position, the damping at the rising edge is forcibly stopped, and the controller controls the lifting valve to perform lifting at a current m14, which returns to zero after the implement is lifted to the middle position or the position in the damping section.

13. The system for controlling vibration damping of the tractor rear hitch according to claim 5, wherein different compensation coefficients are set depending on a position where the damping section is located; when a height limit is at an upper limit position U, force values a, b, c and d are set as trigger determination conditions, and a different compensation coefficient K in a range of [0.8, 1.2] is set for a further implement damping position; when the height limit is higher than the upper limit position U, a value in a range [0.8, 1] is selected as K, the higher the height limit than the upper limit position U, the closer the compensation coefficient K is to 0.8, and the lower the determination force value triggered; and when the height limit is lower than the upper limit position U, a value in a range (1, 1.2] is selected as the compensation coefficient K, the lower the height limit than the upper limit position U, the closer the compensation coefficient is to 1.2, and the higher the determination force value triggered.

14. A tractor, wherein configured with the system for controlling vibration damping of the tractor rear hitch according to claim 1.
